(19) United States
(12) Patent Application Publication
(10) Pub. No.: US 2026/0276591 A1
(43) Pub. Date: Sep. 17, 2026

(54) EDDY CURRENT DEVICES AND METHODS FOR FUEL CHANNEL INSPECTION

(71) Applicant: ONTARIO POWER GENERATION INC., Toronto (CA)

(72) Inventors: Ray TEN GROTENHUIS, Toronto (CA); Yadav VERMA, Brampton (CA); Purba SARKAR, Toronto (CA); Shawn WOOD, Toronto (CA); Andres VILLEGAS, Toronto (CA); Andrew HONG, Toronto (CA)

(73) Assignee: ONTARIO POWER GENERATION INC., Toronto, ON (CA)

(21) Appl. No.: 19/474,779

(22) PCT Filed: Apr. 12, 2024
(86) PCT No.: PCT/CA2024/050481

§ 371 Date: Oct. 13, 2025

Related U.S. Application Data
(60) Provisional application No. 63/495,900, filed on Apr. 13, 2023.

(51) Int. Cl. G01N 27/9013; G01B 7/06; G01N 27/90; G01N 27/904; G21C 17/06

(52) U.S. Cl. CPC G01N 27/902; G01B 7/10; G01N 27/9006; G01N 27/904; G01N 27/9073; G21C 17/06

(57) ABSTRACT

Devices and methods for eddy current inspection of fuel channels. An eddy current inspection device includes an array of eddy current sensors positioned around the outer circumference of a non-rotating section. The device is inserted into the interior of a pressure tube, the active coils of the eddy current sensors are driven in an activation pattern, and data is collected from the reference coils of the eddy current sensors in a collection pattern. The relative placement of the eddy current sensors, the relative placement of the active and reference coils of each eddy current sensor, the activation pattern, and the collection pattern may be configured to mitigate cross-talk and/or maximize sensor coverage of pressure tube regions in between adjacent eddy current sensors.

### RELATED APPLICATION DATA

This application claims priority from related U.S. Provisional Patent Application filed on Apr. 13, 2023 and assigned Ser. No. 63/495,900, which is incorporated herein by reference.

### FIELD

The present disclosure is related to devices and methods for non-destructive inspection of metal conduits, in particular devices and methods for non-destructive inspection of nuclear fuel channels using eddy current sensors.

### BACKGROUND

Non-destructive methods for inspecting metal materials are known in the art, and are used for the inspection of pipes and other conduits, including metal fuel channels used in nuclear power plants. Eddy current sensors (aka gap sensors or eddy current transducers) are one known technology for determining various properties of metal conduits based on the electrical and magnetic properties of local regions of the conduit. Conventional eddy current inspection uses a conductive coil carrying an alternating current (an “active coil”) positioned in a close spatial relationship to a local region of the conduit. The coil generates a magnetic field that varies over time in accordance with the alternative current. The time-varying magnetic field induces eddy currents in the local region of the conduit, and a second coil (the “reference coil”) detects changes in the phase and magnitude of these eddy currents.

Alternatively, changes in the amount of current flowing through the active coil may be monitored. The electrical conductivity and/or magnetic permeability of the conduit material may change the phase and amplitude of the current flowing through the active coil over time.

In the context of nuclear fuel channel inspection, existing approaches to eddy current inspection use a tool fitted with a rotating array of eddy current sensors to inspect the interior of a fuel channel. Each fuel channel includes a pressure tube (PT) suspended inside of a calandria tube (also called a sleeve) by means of end fitting and centering modules. The rotating tool is inserted into the interior of the pressure tube, and the eddy current sensors, positioned on the exterior surface of the tool facing toward the interior surface of the pressure tube, rotate around the interior circumference of the pressure tube as the tool is axially inserted or withdrawn to sense eddy currents in a helical pattern around the circumference of the pressure tube while moving along its axial dimension.

However, the rotating movement of the tool used by existing approaches generates certain artifacts that limit the accuracy of the inspection data generated thereby, and/or limit the efficiency of data collection. First, the rotational movement of the tool can cause vibration of the tool within the pressure tube. Second, the rotational movement of the tool can cause vibration of the pressure tube within the calandria tube. Third, the rotating design of the tool limits the number of eddy current sensors that could be included, potentially leading to spatial gaps in the data and/or slow collection of data.

Accordingly, it is desirable to provide a device for eddy current inspection of fuel channels that overcomes one or more of the limitations of existing approaches.

### SUMMARY

In various examples, the present disclosure describes devices and methods for eddy current inspection of fuel channels. In some embodiments, an eddy current inspection device includes an array of eddy current sensors positioned around the outer circumference of a non-rotating section. Each eddy current sensor includes an active coil and one or more reference coils. The device is inserted into the interior of a pressure tube, the active coils of the eddy current sensors are driven in an activation pattern, and data is collected from the reference coils of the eddy current sensors in a collection pattern. The relative placement of the eddy current sensors, the relative placement of the active and reference coils of each eddy current sensor, the activation pattern, and the collection pattern may be configured to mitigate cross-talk and/or maximize sensor coverage of pressure tube regions in between adjacent eddy current sensors.

In some embodiments, the device uses the reference coils to detect multiple properties of the back electromotive force (EMF) caused by the wall thickness and resistivity of the pressure tube and/or calandria tube. Changes in impedance may be measured by the reference coils to determine wall thickness, wall material(s), and/or gap distance between an exterior surface of the pressure tube and an interior surface of the calandria tube.

In some embodiments, the device may include a greater number of eddy current sensors along a lower arc of the circumference of the device than along an upper arc of the circumference of the device, in order to increase the resolution of the data collected with respect the bottom portion of the pressure tube. This increased resolution may assist in detecting sagging of the pressure tube inside the calandria tube, resulting in risk of the bottom exterior surface of the pressure tube coming into contact with the bottom interior surface of the calandria tube.

In some embodiments, the active coils of the eddy current sensors may include a ferrite core to focus the magnetic field, thereby potentially enabling deeper penetration of the magnetic field into and through the pressure tube material.

In some example aspects, the present disclosure describes a device for inspecting a metal conduit, comprising a body configured to be inserted into an interior cavity of a pressure tube of the fuel channel along an axial dimension of the pressure tube; a plurality of eddy current sensors, each respective eddy current sensor being affixed to the body at a respective circumferential position about a perimeter of the body and comprising: an active coil oriented to induce an eddy current in a respective activation circumferential portion of an interior surface of the pressure tube; and one or more reference coils, each oriented to measure a magnetic field with respect to a respective reference circumferential portion of the pressure tube; and control circuitry configured to activate the active coils according to an activation pattern such that each respective active coil induces an eddy current at each of a plurality of axial locations of the respective activation circumferential portion of the pressure tube; and data collection circuitry configured to collect magnetic field data from the reference coils according to a collection pattern such that magnetic field data is collected from each respective reference coil with respect to each of a plurality of axial locations of the respective reference circumferential portion of the pressure tube.

In another embodiment, the device has a plurality of centering modules, each affixed to the body at a respective circumferential position about the perimeter of the body, jointly configured to radially center the device relative to the interior surface of the pressure tube.

The activation pattern and collection pattern may be configured to mitigate cross-talk from multiple active coils in the magnetic field data collected from the reference coils. They may be configured to generate magnetic field data that may be processed to interpolate magnetic field data for circumferential portions of the pressure tube in between pairs of eddy current sensors.

In an embodiment, the data collection circuitry is further configured to process the magnetic field data collected from the reference coils to determine a wall thickness of the pressure tube at one or more locations. In another embodiment, the data collection circuitry is further configured to process the magnetic field data collected from the reference coils to determine a wall material composition based on the resistivity of the pressure tube at one or more locations. In a further embodiment, the data collection circuitry is further configured to process the magnetic field data collected from the reference coils to determine one or more distances between the device and one or more respective locations of the interior surface of the pressure tube.

The device may configured for locating within an interior cavity of a calandria tube of a fuel channel; and the data collection circuitry may be further configured to process the magnetic field data collected from the reference coils to determine a width of a gap between an exterior surface of the pressure tube and an interior surface of the calandria tube.

A tether may be attached to the body, the tether comprising a communication link operably coupled to the control circuitry and the data collection circuitry; and a power link for providing electrical power to the active coils. The communication link may comprise an optical communication link. The control circuitry may be configured to receive control data from the communication link; and activate the active coils according to the activation pattern based on the control data. The control data may be multiplexed control data. The control circuitry may include an optical demodulator for receiving the optical multiplexed control data.

The data collection circuitry may be configured to process the magnetic field data collected from the reference coils to generate inspection data; and transmit the inspection data on the communication link. The inspection data may comprise multiplexed inspection data. The data collection circuitry includes an optical modulator for transmitting the optical multiplexed inspection data.

Also taught is a method for inspecting a fuel channel, comprising inserting, into an interior cavity of a pressure tube of the fuel channel along an axial dimension of the pressure tube, a device including a plurality of eddy current sensors, each respective eddy current sensor being fixedly oriented toward a respective circumferential portion of an interior surface of the pressure tube; displacing the device with respect to the axial dimension; and while displacing the device with respect to the axial dimension activating an active coil of each eddy current sensor according to an activation pattern such that each respective active coil induces an eddy current at each of a plurality of axial locations along a respective circumferential portion of the pressure tube; and collecting magnetic field data from at least one reference coil of each eddy current sensor according to a collection pattern such that magnetic field data is collected from each respective reference coil with respect to each of a plurality of axial locations along a respective circumferential portion of the pressure tube.

### BRIEF DESCRIPTION OF THE DRAWINGS

Reference will now be made, by way of example, to the accompanying drawings which show example embodiments of the present application, and in which:

FIG. 1 is an front left perspective view of an eddy inspection device, in accordance with examples of the present disclosure;

FIG. 2 is a front cross-sectional elevation view of an eddy current sensor section of the eddy inspection device of FIG. 1;

FIG. 3A is a front cross-sectional elevation view of a second example eddy current sensor section of the eddy inspection device of FIG. 1;

FIG. 3B is a front cross-sectional elevation view of a third example eddy current sensor section of the eddy inspection device of FIG. 1;

FIG. 4 is a front cross-sectional elevation view of a calandria tube, a pressure tube, and the eddy current sensor section of FIG. 2, showing the eddy current inspection device inserted into the interior of the pressure tube;

FIG. 5A is a front view of a first example eddy current sensor, in accordance with examples of the present disclosure;

FIG. 5B is a front view of a second example eddy current sensor, in accordance with examples of the present disclosure; and

FIG. 6 is a flowchart showing steps of an example method for eddy current inspection of a fuel channel, in accordance with examples of the present disclosure.

Similar reference numerals may have been used in different figures to denote similar components.

### DESCRIPTION OF EXAMPLE EMBODIMENTS

The present disclosure describes example devices and methods for eddy current inspection of fuel channels, using a device having multiple eddy current sensors arranged around the perimeter of a non-rotating section of the device.

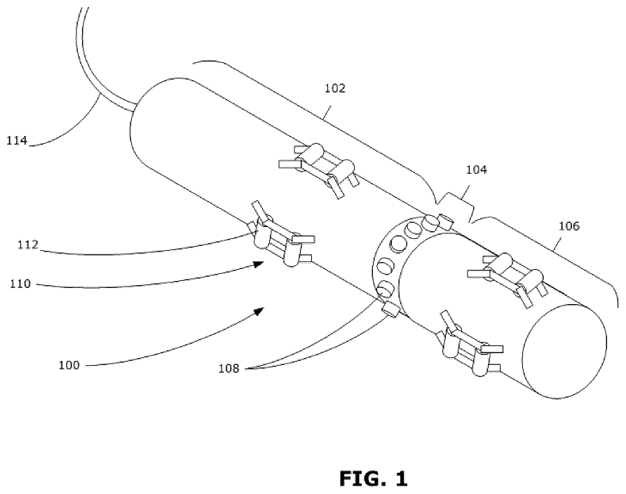

FIG. 1 shows an eddy inspection device 100. The device 100 has a body including a forward section 106, an eddy current sensor section 104, and a rear section 102. The device 100 is longitudinal in shape and configured to be inserted into the interior cavity of a pressure tube of a fuel channel, forward section 106 first.

The illustrated device 100 includes a tether 114 extending out of a rear opening of the pressure tube for communication with equipment exterior to the fuel channel. The tether 114 may include a communication link (such as an electrical communication link or an optical communication link) for bidirectional communication with external data processing equipment and/or a power link for supplying electrical power from an external power source.

The illustrated device 100 includes centering modules 110 on the forward section 106 and rear section 102. There may be multiple centering modules 110 at each of one or more axial locations, e.g., three centering modules 110 at three equidistant circumferential positions around a first axial position on the rear section 102, and another three centering modules 110 at three equidistant circumferential positions around a second axial position on the forward section 106. The centering modules 110 may be operable to radially center the device 100 within the circular interior cavity of the pressure tube, for example by using actuators to extend radially outward from the device body, or by being biased radially outward by biasing means such as springs. The centering modules 110 may include rollers 112 for assisting with axial displacement of the device 100 within the pressure tube; in some embodiments, the rollers 112 may be actuated (e.g., using electric motors or hydraulics) to actively displace the device 100 axially within the pressure tube. In some embodiments, the forward section 106 may not be present, and the eddy current sensor section 104 may constitute a head (i.e. forward-most portion) of the device 100. In some such embodiments, sets of centering modules 110 may be placed at two or more axially separated locations of the rear section 102 to assist in centering and stabilizing the tool within the conduit.

The eddy current sensor section 104 of the device 100 includes a plurality of eddy current sensors 108. Each eddy current sensor 108 is affixed to the eddy current sensor section 104 at a respective circumferential position about the body of the device 100. The positioning of these eddy current sensors 108 allows each sensor 108 to induce eddy currents and sense the resulting magnetic fields at a corresponding circumferential portion of the interior of the pressure tube or other metal conduit being inspected. As the device 100 is displaced axially within the conduit (i.e. along the length of the pressure tube or conduit), without being rotated, each sensor 108 traverses an axial length of its respective circumferential portion of the interior surface of the conduit, generating magnetic field data for an axial strip or a plurality of axial locations of its respective circumferential portion of the conduit.

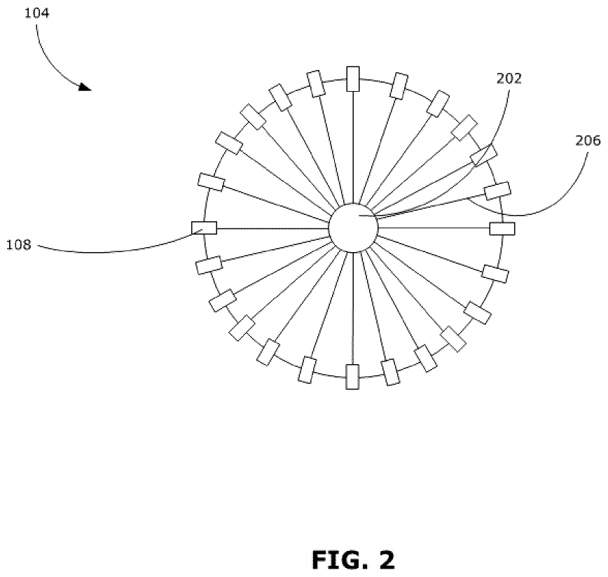

FIG. 2 shows a front cross-section of the eddy current sensor section 104 of an example eddy inspection device. The section 104 includes an instrumentation core 202 containing circuitry for controlling the eddy current sensors 108 and collecting magnetic field data from the eddy current sensors 108. In the example embodiment shown in FIG. 2, the eddy current sensors 108 are arranged uniformly about the perimeter of the device 100, such that each eddy current sensor 108 is positioned to inspect an equally-sized circumferential portion (i.e. equal-length circumferential arcs) of the conduit.

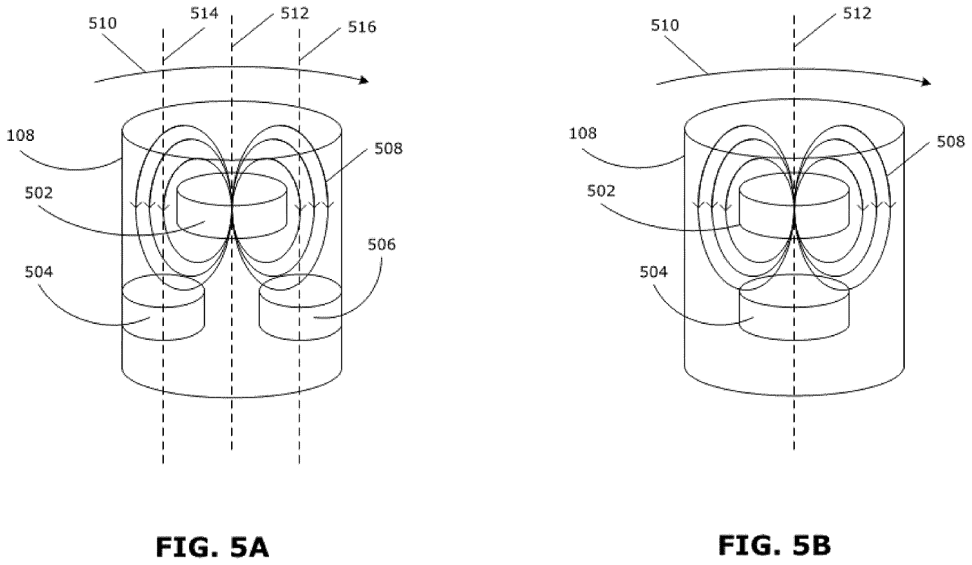

Each eddy current sensor 108 includes an active coil and one or more reference coils (i.e. passive sensing coils or receive coils). In a preferred embodiment, each eddy current sensor 108 includes one active/send coil and two passive/receive/reference coils. The active coils may be activated by passing an electrical current through some or all of the active coils to induce eddy currents in their respective circumferential portions of the interior surface of the pressure tube. Activation of the active coils may be effected according to a time-varying activation pattern, which may be controlled using electrical control signals. Similarly, the passive coils may collect magnetic field data from respective circumferential portions of the interior surface of the pressure tube according to a time-varying collection pattern. Depending on the configurations of the individual sensors 108, as described with reference to FIGS. 5A-5B below, the circumferential portion of the conduit stimulated by the active coil of a given sensor 108 may be the same or a different section from the circumferential portion of the conduit monitored by the one or more passive coils of the given sensor 108.

An electrical link 206 connects each sensor 108 to the instrumentation core 202. The instrumentation core 202 may contain circuitry configured to send the control signals to the active coils of the sensor 108, via the electrical links 206, in accordance with the activation pattern. Similarly, the instrumentation core 202 may contain circuitry configured to collect the magnetic field data from the passive coils of the sensors 108 via the electrical links 206 according to the collection pattern.

The instrumentation core 202 may include one or more circuit components, such as one or more printed circuit boards (PCBs) and/or application-specific integrated circuits (ASICs). In some embodiments, the instrumentation core 202 includes an optical modulator and/or an optical demodulator, such as an electro-optical modulator (EOM) and/or a photodiode, for converting electrical signals to and from the optical domain. The communication link of the tether 114 (see FIG. 1) may be an optical link in some embodiments. In some examples, the instrumentation core 202 may include control circuitry configured to receive control data from the tether 114 (such as multiplexed optical signal data), and to activate the active coils according to the activation pattern based on the received control data. In some examples, the instrumentation core 202 may include data collection circuitry configured to receive magnetic field data from the reference coils according to the collection pattern, and to transmit inspection data via the tether 114 (such as multiplexed optical signal data) based on the magnetic field data. The control data may be generated by control equipment located outside of the conduit and sent to the device 100 via the tether 114. The inspection data may be received over the tether 114 by data processing equipment located outside of the conduit and processed for analysis. In some embodiments, the control data and inspection data are multiplexed and communicated bidirectionally (i.e. control data to the device 100, inspection data from the device 100) over a multiplexed or bidiretional communication link, such as an optical or electrical communication link.

In some embodiments, the tether 114 may also include a power link for supplying external power from an external power source to the sensors 108 and/or other powered components of the device 100 (such as actuated centering modules 110 and/or rollers 112). In some embodiments, the device 100 may include an internal power source for powering one or more of its powered components.

The example device 100 shown in FIG. 2 includes 24 eddy current sensors 108 arranged uniformly about the perimeter of the eddy current sensor section 104. By including a large number of eddy current sensors 108, such as 12 or more sensors 108, or 24 or more sensors 108, the device 100 may obviate the need to rotate while inspecting the conduit, thereby eliminating the undesirable artifacts of ration described above and increasing the accuracy of the inspection data.

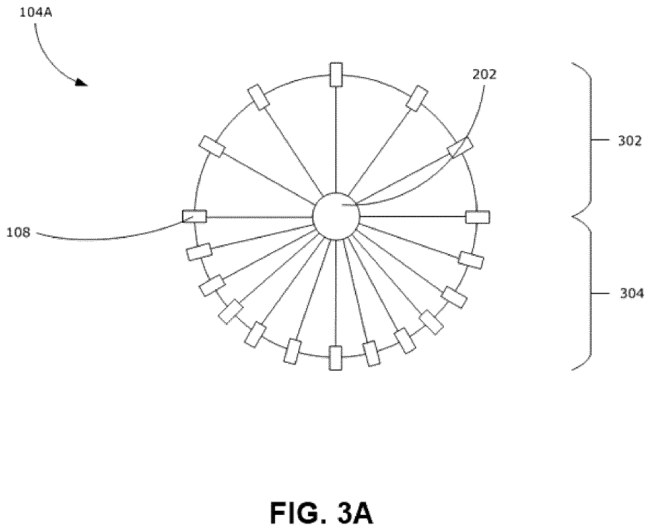

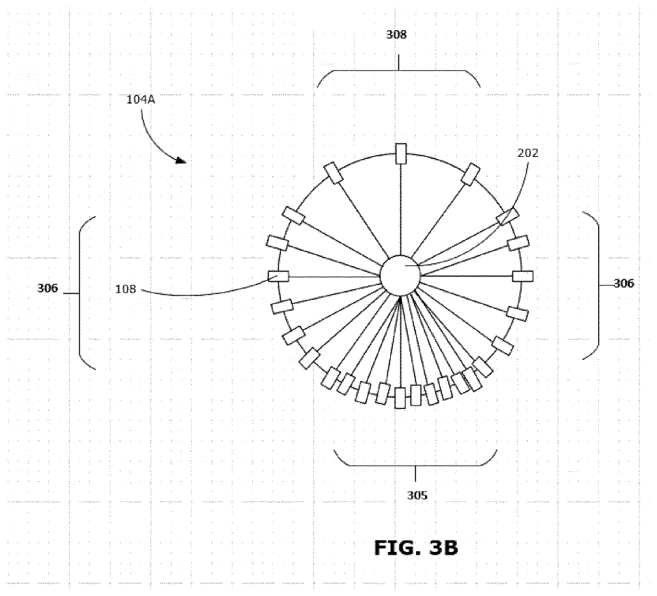

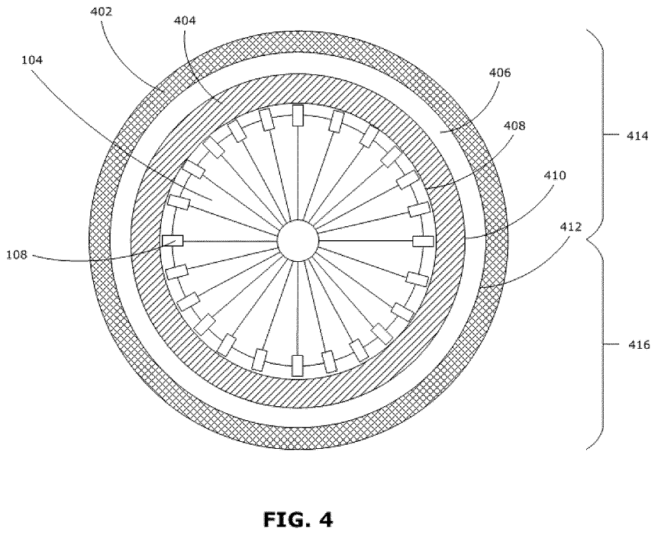

FIG. 3A shows a second example eddy current sensor section 104A of the eddy inspection device 100, in which the eddy current sensors 108 are arranged non-uniformly about the perimeter of the device 100. In some embodiments, a lower portion 304 of the device 100 may have a more dense concentration of sensors 108 than an upper portion 302 of the device 100. The greater number of sensors 108 along the lower portion 304 enables generation of higher-resolution and higher-accuracy inspection data with respect to the corresponding bottom portion of the conduit. This may be desirable in order to detect sagging of the pressure tube within the calandria tube, as described further below with reference to FIG. 4. Sagging of the pressure tube may be caused by a combination of gravity, misalignment of centering modules within the calandria tube, and degradation of the pressure tube material, and it presents a risk of the pressure tube coming into contact with the calandria tube, which can cause serious safety and integrity problems if not detected and mitigated.

FIG. 3B shows a second example eddy current sensor section 104A of the eddy inspection device 100, in which the eddy current sensors 108 are again arranged non-uniformly about the perimeter of the device 100. In some embodiments, a lower 90 degree arc portion 305 of the device 100 may have a more dense concentration of sensors 108 than lateral 90 degree arc portions 306 of the device 100, and the upper 90 degree arc portion 308 of the device 100 may have a less dense concentration of sensors 108 than the lateral 90 degree arc portions 306 of the device 100. The greater number of sensors 108 along the lower portion 304 enables generation of higher-resolution and higher-accuracy inspection data with respect to the corresponding bottom portion of the conduit. This may be desirable in order to detect sagging of the pressure tube within the calandria tube, as described further below with reference to FIG. 4. Sagging of the pressure tube may be caused by a combination of gravity, misalignment of centering modules within the calandria tube, and degradation of the pressure tube material, and it presents a risk of the pressure tube coming into contact with the calandria tube, which can cause serious safety and integrity problems if not detected and mitigated.

FIG. 4 shows a front cross-sectional view of a calandria tube 402, a pressure tube 404, and the eddy current sensor section 104 of the eddy current inspection device 100, showing the eddy current inspection device 100 inserted into the interior of the pressure tube 404. In operation, the centering modules 110 (not shown) of the device 100 radially center the device 100 within the pressure tube 404 such that the eddy current sensors 108 are in contact, or in very close proximity, to an interior surface 408 of the pressure tube 404. When the active coils of the sensors 108 are activated according to the activation pattern, and magnetic field data is collected by the reference coils of the sensors 108, the thickness of the walls of the pressure tube 404 and calandria tube 402, and their resistivity, create back EMF. The magnetic field data collected by the reference coils, and/or variations in current passing through the active coils, may be used to detect multiple properties of the pressure tube 404 and/or the calandria tube based on changes in impedance: for example, changes in wall thickness, material composition, and shape of the pressure tube 404 and/or calandria tube 408 may be detected, as well as the width of the gap 406 between the interior surface 412 of the calandria tube 402 and an exterior surface 410 of the pressure tube 404.

In some examples, an eddy current inspection device 100 such as the embodiment of FIG. 3A may be used to inspect a fuel channel. Because the eddy current sensor section 104A of the device 100 has a greater number of eddy current sensors 108 on its lower portion 304 than its upper portion 302, the resolution of the magnetic field data collected with respect to the lower portion 416 of the pressure tube 404, the gap 406, and the calandria tube 408 may be greater than the resolution of the magnetic field data collected with respect to the upper portion 414 thereof, potentially improving the ability of the device 100 to detect sagging of the pressure tube 404 inside the calandria tube 408.

FIG. 5A shows a first example configuration of a single eddy current sensor 108 having a single active coil 502 and two reference coils 504, 506. In this embodiment, the first reference coil 504 is spaced apart from the second reference coil 506 with respect to a circumferential direction 510. Both reference coils 504, 506 are also displaced from the position of the active coil 502 with respect to the circumferential direction 510. Thus, the center line 514 of the first reference coil 504 (i.e. passing through the axial center of the coil 504) defines a first circumferential portion of the pressure tube or other conduit centered on center line 514. The magnetic field data collected by the first reference coil 504 may be considered to be spatially situated with respect to the circumferential region centered on center line 514. Similarly, the center line 516 of the second reference coil 506 (i.e. passing through the axial center of the coil 506) defines a second circumferential portion of the pressure tube or other conduit centered on center line 516, and the magnetic field data collected by the second reference coil 506 may be considered to be spatially situated with respect to the circumferential region centered on center line 516. The active coil 502 has center line 512, which defines the center point of a circumferential region of the conduit stimulated by the magnetic field 508 generated by active coil 502, thereby producing eddy currents and generating its own magnetic field that may be sensed by the reference coils 504, 506 and/or by current fluctuations in the active coil 502.

FIG. 5B shows a second example configuration of an eddy current sensor 108, having a single active coil 502 and a single reference coil 504. In this embodiment, the reference coil 504 shares a common center line 512 with the active coil 502, and so the circumferential portion of the conduit stimulated by the active coil 502 and monitored by the reference coil 504 are the same circumferential portion.

It will be appreciated that other configurations of eddy current sensors 108 are possible in addition to those shown in FIGS. 5A-5B. For example, in some embodiments the two reference coils 504, 506 of a sensor 108 may be displaced from each other in a radial direction instead of a circumferential direction (with respect to the conduit). I.e., the active coil 502 and both reference coils 504, 506, may share a common center line 512, with a first reference coil 504 being positioned closer to the pressure tube interior surface 408 than the second reference coil 506.

The reference coils of adjacent eddy current sensors 108 may be positioned to maximize the circumferential coverage of magnetic field measurements. In some examples, magnetic field measurements in between the reference coils of adjacent eddy current sensors 108 may be estimated through interpolation of the magnetic field measurements of the reference coils as represented in the magnetic field data.

In some examples, the activation pattern of the active coils 502 of the set of sensors 108 is configured to mitigate or minimize cross-talk from multiple active coils 502. For example, the activation pattern may activate only non-adjacent active coils 502 at a given point in time: in a device 100 having 24 sensors 108 sequentially numbered from 0 to 23 in a clockwise direction around the perimeter of the device 100, the activation pattern may first activate all odd-numbered active coils 502 for a first epoch, then deactivate all odd-numbered active coils 502 for a second epoch to allow the fields to attenuate, then activate all even-numbered active coils 502 for a third epoch, then deactivate all even-numbered active coils 502 for a fourth epoch, before displacing the device 100 axially (e.g., using actuated rollers 112) for a new set of measurements at a new axial position of the device 100. Similarly, the collection pattern of the reference coils may be configured to collect magnetic field data from all or a subset of the reference coils during each epoch, depending on factors such as the interference likely to be encountered by a given subset of the reference coils during a given epoch of the activation pattern, the need for more magnetic field data at a given subset of circumferential portions of the conduit, the data compression and transmission limitations of the instrumentation core 202 and tether 114, and so on. In some examples, depending on factors such as spacing of the sensors 108 relative to each other, every third or fourth sensor 108 may be activated in a given epoch instead of every other sensor 108.

In some examples, multiple different electrical signal frequencies may be used to drive the active coils 502 during some or all epochs of the activation pattern. Both high and low frequencies may be used, in the same epoch or in different epochs. For example, an activation pattern may drive a subset of the active coils 502 with a high-frequency sinusoidal signal (such as 6 KHz or 8 KHz) during a first epoch to achieve high resolution of the magnetic field data, at the expense of poor penetration of the material of the pressure tube 404. The activation pattern may drive a subset of the active coils 502 with a low-frequency sinusoidal signal (such as 2 KHz or 4 KHz) during a second epoch to achieve deeper penetration of the material of the pressure tube 404, at the expense of some degree of resolution of the magnetic field data. It will be appreciated that multiple different frequencies may be used in some embodiments to achieve multiple different trade-offs between penetration and resolution, such as 2, 4, 6, and 8 KHz sinusoidal signals.

In some embodiments, the active coils 502 may use a ferrite core to concentrate or focus the magnetic field 508, enabling deeper penetration through the material of the pressure tube 404 and/or calandria tube 408.

In some embodiments, the activation pattern and collection pattern, and the operations of the instrumentation core 202 and sensors 108 more generally, are configured to compensate for various types of interference. The pressure tube 404 will exhibit variations in local resistivity which affect the induced eddy currents, and hence a secondary impedance of the pressure tube 404 is measured. The variations in secondary impedance may be compensated for in some examples by measuring the secondary impedance and/or the variations in local resistivity of the pressure tube 404 (and/or the calandria tube) using a higher frequency drive signal (e.g., 32 kHz) as part of the activation pattern. The pressure tube 404 wall thickness will also alter the sensed impedance change. Changes in pressure tube 404 wall thickness may be detected using other techniques, such as ultrasound inspection, which may be integrated into the device 100 in some embodiments. The impedance changes caused by material resistivity and wall thickness of the pressure tube 404 may be compensated for with respect to multiple activation pattern-collection pattern interactions, e.g., compensation may be effected for both the interaction between activation of the active coil 502 and measurement by the first reference coil 504, and between activation of the active coil 502 and measurement by the second reference coil 506. The remaining changes in impedance for both coil pairs (502 and 504; 502 and 506) are may be inferred to be caused by the proximity of the calandria tube 408 to the pressure tube 404 (i.e., a decrease in the width of gap 406). This inference may be calibrated to a baseline using a calibration specimen (e.g., a fuel channel having a pressure tube and calandria tube of known material composition, shape, and spacing) and hence a known width of the gap 406 between these two bodies 404, 408.

In some embodiments, the active coils 502 and/or reference coils may be relatively large in size. The relatively large size of the coils combined with their spacing about the circumference of the eddy current sensor section 104 may permit the use of a range of drive frequencies and coil activation/collection combinations that provide accurate measurements while maintaining spatial resolution despite axial motion of the device 100 within the conduit being inspected.

In some embodiments, the coils in circumferentially adjacent sensors 108 may be used to obtain additional impedance measurements in the circumferential direction, i.e., between the individual sensors 108, for example by interpolating between the measurements obtained at individual sensors 108.

In some examples, an activation pattern that uses alternate activation of subsets of the active coils 502 and/or alternate collection from a subset of reference coils within a given epoch may be used to assist with multiplexing the signals used to drive the active coils and/or the data collected from the reference coils. In some embodiments, this multiplexing of control data and/or magnetic field data may allow the number of conductors in the device 100 (e.g., the number of electrical links 206 and/or the number of conductors of the instrumentation core 202) to be reduced. However, in some such embodiments, the measurements processed by the instrumentation core 202 may need to be re-balanced upon each change in the activation pattern and/or collection pattern (e.g., after each epoch), due to system impedance being unique to each electrical link 206, which may in turn affect the highly eddy currents.

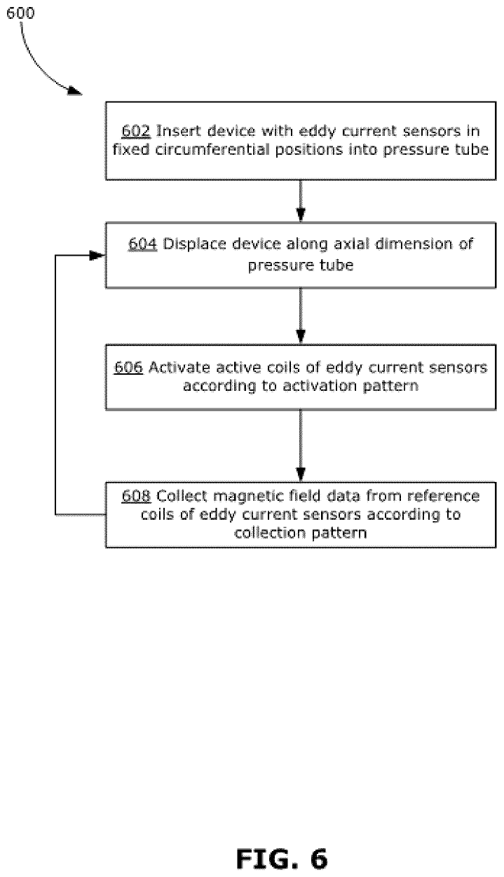

FIG. 6 shows steps of an example method 600 for eddy current inspection of a fuel channel. Method 600 will be described in reference to eddy current inspection device 100. However, it will be appreciated that other means may be used to perform the steps of method 600.

At 602, a device 100 including a plurality of eddy current sensors 108 is inserted into an interior cavity of a pressure tube 404 of the fuel channel, along an axial dimension of the pressure tube 404. Each respective eddy current sensor 108 is fixedly oriented toward a respective circumferential portion of an interior surface 408 of the pressure tube 404.

At 604, the device is displaced with respect to the axial dimension (i.e., either withdrawn or inserted).

At 606, an active coil 502 of each eddy current sensor 108 is activated according to an activation pattern such that each respective active coil 502 induces an eddy current at each of a plurality of axial locations along a respective circumferential portion of the pressure tube 404.

At 608, magnetic field data is collected from at least one reference coil 504, 506 of each eddy current sensor 108 according to a collection pattern, such that magnetic field data is collected from each respective reference coil 504, 506 with respect to each of a plurality of axial locations along a respective circumferential portion of the pressure tube 404.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed.

Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A device for inspecting a metal conduit, comprising:
a body configured to be inserted into an interior cavity of a pressure tube of the fuel channel along an axial dimension of the pressure tube;
a plurality of eddy current sensors, each respective eddy current sensor being affixed to the body at a respective circumferential position about a perimeter of the body and comprising:
an active coil oriented to induce an eddy current in a respective activation circumferential portion of an interior surface of the pressure tube; and
one or more reference coils, each oriented to measure a magnetic field with respect to a respective reference circumferential portion of the pressure tube; and
control circuitry configured to activate the active coils according to an activation pattern such that each respective active coil induces an eddy current at each of a plurality of axial locations of the respective activation circumferential portion of the pressure tube; and
data collection circuitry configured to collect magnetic field data from the reference coils according to a collection pattern such that magnetic field data is collected from each respective reference coil with respect to each of a plurality of axial locations of the respective reference circumferential portion of the pressure tube.

2. The device of claim 1, further comprising:
a plurality of centering modules, each affixed to the body at a respective circumferential position about the perimeter of the body, jointly configured to radially center the device relative to the interior surface of the pressure tube.

3. The device of claim 1, wherein:
the one or more reference coils of each eddy current sensor comprises:
two reference coils oriented to measure the magnetic field with respect to two respective reference circumferential portions of the pressure tube.

4. The device of claims 1, wherein:
the activation pattern and collection pattern are configured to mitigate cross-talk from multiple active coils in the magnetic field data collected from the reference coils.

5. The device of claims 1, wherein:
the activation pattern and collection pattern are configured to generate magnetic field data that may be processed to interpolate magnetic field data for circumferential portions of the pressure tube in between pairs of eddy current sensors.

6. (canceled)

7. The device of claims 1, wherein:
a lower portion of the body, defining a lower 180 degree circumferential arc of the pressure tube, includes a first number of the eddy current sensors;
an upper portion of the body, defining an upper 180 degree circumferential arc of the pressure tube, includes a second number of the eddy current sensors; and
the second number is lower than the first number.

8. The device of claims 1, wherein:
a lower portion of the body, defining a lower 90 degree circumferential arc of the pressure tube, includes a first number of the eddy current sensors;
an upper portion of the body, defining an upper 90 degree circumferential arc of the pressure tube, includes a second number of the eddy current sensors; and
two side portions of the body, defining lateral 90 degree circumferential arcs of the pressure tube, each includes a third number of the eddy current sensors; and
the second number is lower than the third number and the third number is lower than the first number.

9. The device of claims 1, wherein:
the plurality of eddy current sensors comprises about 24 eddy current sensors.

10. The device of claims 1, wherein:
each of the plurality of eddy current sensors comprises one send coil and two receive coils.

11. The device of claims 1, wherein:
the data collection circuitry is further configured to process the magnetic field data collected from the reference coils to determine a wall thickness of the pressure tube at one or more locations.

12. The device of claims 1, wherein:
the data collection circuitry is further configured to process the magnetic field data collected from the reference coils to determine a wall material composition based on the resistivity of the pressure tube at one or more locations.

13. The device of claims 1, wherein:
the data collection circuitry is further configured to process the magnetic field data collected from the reference coils to determine one or more distances between the device and one or more respective locations of the interior surface of the pressure tube.

14. The device of claims 1, wherein:
the device is configured for locating within an interior cavity of a calandria tube of a fuel channel; and
the data collection circuitry is further configured to process the magnetic field data collected from the reference coils to determine a width of a gap between an exterior surface of the pressure tube and an interior surface of the calandria tube.

15. The device of claims 1, further comprising:
a tether attached to the body, the tether comprising:
a communication link operably coupled to the control circuitry and the data collection circuitry; and
a power link for providing electrical power to the active coils.

16. (canceled)

17. The device of claim 15, wherein:
the control circuitry is further configured to:
receive control data from the communication link; and
activate the active coils according to the activation pattern based on the control data.

18. The device of claim 17, wherein:
the control data comprises multiplexed control data.

19. The device of claims 15, wherein:
the communication link comprises an optical communication link;
the multiplexed control data comprises optical multiplexed control data; and
the control circuitry includes an optical demodulator for receiving the optical multiplexed control data.

20. The device of claims 1, wherein:
the data collection circuitry is configured to:
process the magnetic field data collected from the reference coils to generate inspection data; and
transmit the inspection data on the communication link.

21. (canceled)

22. The device of claim 20, wherein:
the communication link comprises an optical communication link;
the inspection data comprises multiplexed inspection data;
the multiplexed inspection data comprises optical multiplexed inspection data; and
the data collection circuitry includes an optical modulator for transmitting the optical multiplexed inspection data.

23. A method for inspecting a fuel channel, comprising:
inserting, into an interior cavity of a pressure tube of the fuel channel along an axial dimension of the pressure tube, a device including a plurality of eddy current sensors, each respective eddy current sensor being fixedly oriented toward a respective circumferential portion of an interior surface of the pressure tube;
displacing the device with respect to the axial dimension; and
while displacing the device with respect to the axial dimension:
activating an active coil of each eddy current sensor according to an activation pattern such that each respective active coil induces an eddy current at each of a plurality of axial locations along a respective circumferential portion of the pressure tube; and
collecting magnetic field data from at least one reference coil of each eddy current sensor according to a collection pattern such that magnetic field data is collected from each respective reference coil with respect to each of a plurality of axial locations along a respective circumferential portion of the pressure tube.
